(19) United States
(12) Patent Application Publication
(10) Pub. No.: US 2005/0112428 A1
(43) Pub. Date: May 26, 2005

(54) Fuel cell power system having multiple fuel cell modules

(75) Inventors: Norman A. Freeman, Richmond Hill (CA); Stephen Burany, Thornhill (CA)

Correspondence Address: OGILVY RENAULT, 1981 MCGILL COLLEGE AVENUE, SUITE 1600, MONTREAL, QC, H3A2Y3, CA

(73) Assignee: HYDROGENICS CORPORATION, Mississauga (CA)

(21) Appl. No.: 10/969,967

(22) Filed: Oct. 22, 2004

Related U.S. Application Data
(60) Provisional application No. 60/513,221, filed on Oct. 23, 2003.

(51) Int. Cl. H01M 8/04; H01M 8/24

(52) U.S. Cl. 429/22; 429/13

(57) ABSTRACT

A fuel cell power system has a plurality of fuel cell power modules, each module including a fuel cell and associated peripheral devices. Each fuel cell power module is controlled by its own local controller. A master controller controls each of the local controllers in accordance with overall system requirements. Optionally, a bypass allows the master controller to shut down and bypass a particular fuel cell power module, providing this system with greater flexibility, robustness and reliability. The modular system architecture also simplifies manufacturing, maintenance and repair.

### CROSS-REFERENCE TO RELATED APPLICATIONS

This application claims priority from U.S. Provisional Patent Application Ser. No. 60/513,221 filed Oct. 23, 2003.

### FIELD OF THE INVENTION

The present invention relates generally to a fuel cell power system and, more particularly, to a method of operating a fuel cell power system having multiple fuel cell modules.

### BACKGROUND OF THE INVENTION

A fuel cell is an electrochemical device that produces an electromotive force by bringing the fuel (typically hydrogen) and an oxidant (typically air) into contact with two suitable electrodes and an electrolyte. A fuel, such as hydrogen gas, for example, is introduced at a first electrode where it reacts electrochemically in the presence of the electrolyte to produce electrons and cations in the first electrode. The electrons are circulated from the first electrode to a second electrode through an electrical circuit connected between the electrodes. Cations pass through the electrolyte to the second electrode. Simultaneously, an oxidant, such as oxygen or air is introduced to the second electrode where the oxidant reacts electrochemically in the presence of the electrolyte and a catalyst, producing anions and consuming the electrons circulated through the electrical circuit. The cations are consumed at the second electrode. The anions formed at the second electrode or cathode react with the cations to form a reaction product. The first electrode or anode may alternatively be referred to as a fuel or oxidizing electrode, and the second electrode may alternatively be referred to as an oxidant or reducing electrode. The half-cell reactions at the first and second electrodes respectively are:
H₂→2H⁺+2e⁻ (1)
½O₂+2H⁺+2e⁻→H₂O (2)

The external electrical circuit withdraws electrical current and thus receives electrical power from the fuel cell. The overall fuel cell reaction produces electrical energy as shown by the sum of the separate half-cell reactions shown in equations 1 and 2. Water and heat are typical by-products of the reaction.

In practice, fuel cells are not operated as single units. Rather, fuel cells are connected in series, either stacked one on top of the other or placed side by side. The series of fuel cells, referred to as a fuel cell stack, is normally enclosed in a housing. The fuel and oxidant are directed through manifolds in the housing to the electrodes. The fuel cell is cooled by either the reactants or a cooling medium. The fuel cell stack also comprises current collectors, cell-to-cell seals and insulation while the required piping and instrumentation are provided external to the fuel cell stack.

Proton exchange membranes (PEMs) require a wet surface to facilitate the conduction of protons from the anode to the cathode, and otherwise to maintain the membranes electrically conductive. Accordingly, the surface of the membrane must remain moist at all times. Fuel cell efficiency is also affected by operating temperature, pressure of the process gases. Therefore, to ensure adequate efficiency, the process gases must have, on entering the fuel cell, appropriate humidity and temperature which are based on the system requirements.

A further consideration is that there is an increasing interest in using fuel cells in transport and like applications, e.g. as the basic power source for cars, buses and even larger vehicles. Automotive applications are quite different from many stationary applications. For example in stationary applications, fuel cell stacks are commonly used as an electrical power source and are simply expected to run at a relatively constant power level for an extended period of time. In contrast, in an automotive environment, the actual power required from the fuel cell stack can vary widely. Additionally, the fuel cell stack supply unit is expected to respond rapidly to changes in power demand, whether these be demands for increased or reduced power, while maintaining high efficiencies. Further, for automotive applications, a fuel cell power unit is expected to operate under an extreme range of ambient temperature and humidity conditions.

All of these requirements are exceedingly demanding and make it difficult to ensure that a fuel cell stack will operate efficiently under all the possible ranges of operating conditions. In order to ensure that a fuel cell power unit can always supply a high power level and at a high efficiency and simultaneously ensure that it has a long life, it is necessary to condition the process fluids for the fuel cell and constantly monitor the operating condition of the fuel cell.

Hence, a number of fuel cell peripheral devices are provided to regulate the operating characteristics of the fuel cell, such as temperature, pressure, humidity, current drawn from the fuel cell, etc. These fuel cell peripheral devices include, but are not limited to, compressors, blowers, storage tanks, flow-regulating valves, pressure-regulating valves, humidifiers, enthalpy exchanging devices, pumps, purge valves, pressure gauges, temperature sensors, water separators, condensers, voltage monitoring devices, controllers, microprocessors, etc. These peripheral devices, together with piping, fittings and other hardware used to connect these devices, as well as a fuel cell stack, are collectively known as a fuel cell power module. The applicant's co-pending U.S. patent application Ser. Nos. 10/122,125, 60/412,547, 60/412,548, 60/412,587, 60/412,588, 60/429,317, 60/429,318, 60/429,323, 10/461,870, disclose examples of fuel cell power modules. It is to be understood that a fuel cell power module may include one or more fuel cell stacks.

In some applications, where a large power output is required, a single fuel cell stack may not be sufficient. A common technique is to use multiple fuel cell stacks connected in series to provide higher voltage and hence higher power. The multiple fuel cell stacks typically share common fuel cell peripherals. Specifically, the multiple fuel cell stacks may have a single source of process fluids, e.g. hydrogen, or coolant. They may also share a common reactant supply device, a common purge line, etc. Although this design offers a simple way to meet the power requirement while minimizing the size of the fuel cell power module, it suffers from a number of problems.

First, the power module has to be custom-made and cannot be scaled up or down. Specifically, when the number of fuel cell stacks in the power system changes, fuel cell peripherals have to be reselected to accommodate the new operating characteristics. Moreover, the fuel cell power module lacks flexibility. Any malfunctioning component tends to deleteriously affect the performance of the overall system and often leads to complete system shutdown.

Therefore, there remains a need for a fuel cell power system having multiple fuel cell stacks which offers modular, scaleable, flexible and robust fuel cell solutions for a variety of different applications.

### SUMMARY OF THE INVENTION

It is therefore an object of the invention to provide a fuel cell power system having multiple, modular fuel cell stacks thus providing flexible, robust and scaleable fuel cell solutions for a variety of applications.

In accordance with one aspect of the invention, a fuel cell power system includes a plurality of fuel cell power modules, each fuel cell power module including a fuel cell for generating electrical power; a plurality of local controllers, each local controller controlling one respective fuel cell power module; and a master controller for controlling the local controllers. By including both local and master controllers, this system provides a two-tier control architecture that is highly flexible, scaleable and robust. Additional fuel cell power modules can thus be added or removed in a modular fashion to accommodate varying power requirements.

Another aspect of the present invention provides a method of controlling a fuel cell power system having a plurality of fuel cell power modules. The method includes the steps of locally controlling each fuel cell power module using a respective local controller; and globally controlling the local controllers using a master controller.

Yet another aspect of the present invention provides a fuel cell power system including a plurality of fuel cell power modules, each fuel cell power module including a fuel cell for generating electrical power and further including associated peripheral devices for supplying reactants to the fuel cell and for collecting current and reaction byproducts from the fuel cell; a plurality of local controllers, each local controller controlling one respective fuel cell power module based on a feedback control loop from sensors disposed in the associated peripheral devices; and a master controller for controlling the local controllers based on a master feedback control loop receiving feedback from each local controller from which the master controller generates control commands for each local controller.

In one embodiment, the fuel cell power system includes at least one bypass for selectively bypassing one or more of the fuel cell power modules. The master controller can shut down and bypass one or more faulty fuel cell power module(s). Alternatively, where overall power requirements decline, the master controller can deactivate and bypass one or more of the fuel cell power modules.

### BRIEF DESCRIPTION OF THE DRAWINGS

Having thus generally described the nature of the invention, reference will now be made to the accompanying drawings, in which:

FIG. 1 shows a schematic of a fuel cell power system in accordance with a first embodiment of the present invention;

FIG. 2 shows a schematic of a fuel cell power system in accordance with a second embodiment of the present invention;

FIG. 3 shows a schematic interaction of the fuel cell power system of FIG. 1 with an overall system controller, such as a vehicle's powerplant control module; and

FIG. 4 shows a schematic of a fuel cell power system in accordance with a third embodiment of the present invention.

### DETAILED DESCRIPTION OF THE PREFERRED EMBODIMENTS

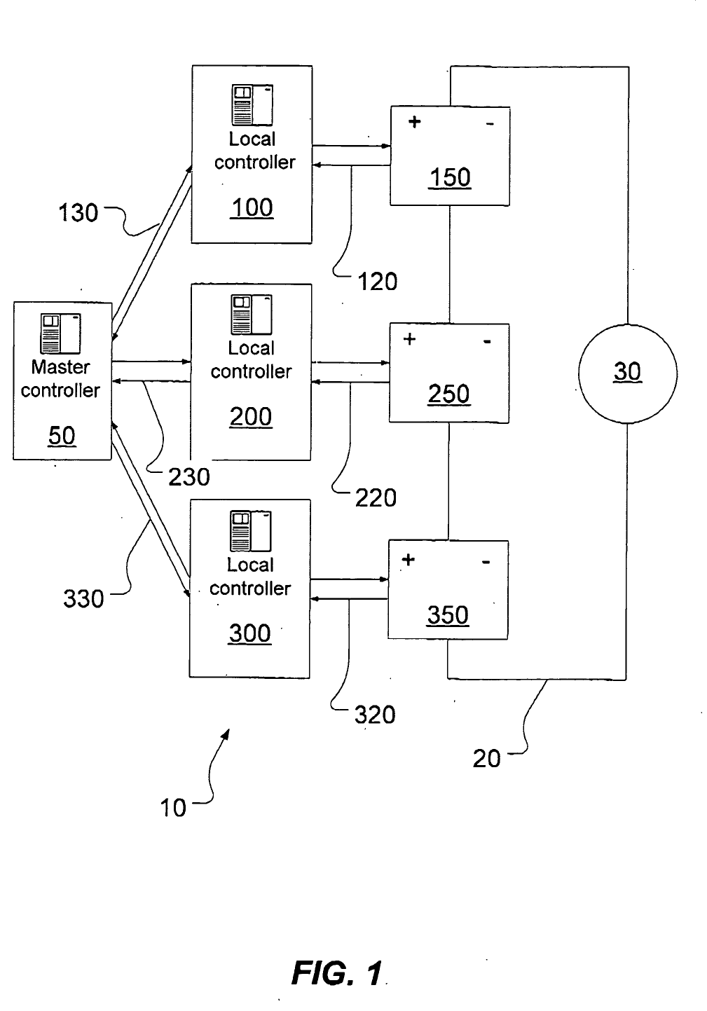

FIG. 1 shows a schematic of a fuel cell power system, generally designated by reference numeral 10, in accordance with a first embodiment of the present invention.

The fuel cell power system 10 includes multiple fuel cell power modules each having a fuel cell and associated peripheral devices for supplying reactants to the fuel cell and for collecting current and reaction byproducts from the fuel cell. FIG. 1 shows a fuel cell power system having three such power modules 150, 250, 350 although it is to be expressly understood that the term “multiple” (or “a plurality of”) should be construed as meaning more than one. In other words, the fuel cell power system 10 according to the present invention has at least two fuel cell power modules. For example, a fuel cell power system used to power a vehicle such as a car (typically requiring about 80-100 kW of power) could use 4 or 5 modules each having a power output of 20 kw. Alternatively, a smaller (or larger) number of modules each having a higher (or lower) power output could be used to satisfy the total power requirement of the system. In other words, it is to be understood that the fuel cell power system 10 in accordance with this invention can be used in a variety of applications, such as providing motive force for cars, buses or other vehicles or to generate electrical power in static power generation applications, e.g. powering wireless stations.

Referring to FIG. 1, the fuel cell power modules 150, 250, 350 can be either identical or different. Examples of fuel cell power modules can be found in the applicant's co-pending U.S. patent application Ser. Nos. 10/122,125, 60/412,547, 60/412,548, 60/412,587, 60/412,588, 60/429,317, 60/429,318, 60/429,323, 10/461,870, which are hereby incorporated by reference in their entirety. Alternatively, the fuel cell power system 10 could utilize any other commercially available fuel cell power modules.

The fuel cell power system 10 further includes a local controller associated with each fuel cell power module. As shown in FIG. 1, a first local controller 100 controls a first fuel cell power module 150. A second local controller 200 controls a second fuel cell power module 250. A third local controller 300 controls a third fuel cell power module 350. Were the system to include additional fuel cell power modules, further local controllers would, of course, be provided in a one-to-one ratio. The fuel cell power system 10 is thus modular and scaleable in the sense that further power modules (with their respective local controllers, of course) can be added. Likewise, the fuel cell power system 10 can be scaled down by removing or deactivating power modules. The fuel cell power system 10 thus provides a two-tier control architecture that is scaleable, modular, robust and flexible. In other words, fuel cell power modules can be added or removed to accommodate a wide range of size restraints and power requirements.

While the local controllers 100, 200, 300 are illustrated in FIG. 1 as being separate and distinct from their respective fuel cell power modules 150, 250, 350, it is to be appreciated that each local controller could also be integrated within its corresponding fuel cell power module for compactness.

The local controllers 100, 200, 300 respectively control the operation of their corresponding fuel cell power modules 150, 250, 350 via data communication lines 120, 220, 320, respectively.

As shown in FIG. 1, the fuel cell power system 10 also includes a master controller 50 for globally controlling the fuel cell power system 10. The master controller 50 is in communication with the local controllers 100, 200, 300 to manage the overall power production of the fuel cell power system 10. The master controller 50 sends commands to the local controllers 100, 200, 300 and receives feedback from the local controllers via data communication lines 130, 230, 330. The master controller 50 is not directly linked with the fuel cell power modules 150, 250, 350 and thus does not directly communicate with the power modules. Instead, the master controller manages power production by relaying individual power production requirements to each of the local controllers (also known as slave controllers).

The master controller 50 thus decides what mode each fuel cell power module is in (e.g. start mode, standby mode, wait/pre-charge mode, run mode, cool-down mode, recovery mode, quick shut-down, cathode purge, anode purge, etc.) When running (i.e. when in run mode), the master controller 50 also determines how much power each module must generate to contribute to the overall power requirement. The master controller 50 receives power requirement signals (also known as a current draw request) from users or other external controllers (e.g. an overall system controller) and monitors overall system performance (total generated power) to ensure that the overall power requirement is satisfied in an optimal and efficient manner.

A variety of sensors (not shown) are disposed throughout the fuel cell power modules for continually (or intermittently) providing signals to the respective local controller to enable the local controller perform routine local feedback control. The local controller processes these signals, comparing them to acceptable thresholds, and then communicates some of this performance data to the master controller 50 which in turn uses a master feedback control algorithm to manage the local controllers. Some or all of the performance data received by the master controller is then communicated to the overall system controller. In other words, the master controller 50 selectively relays certain performance data to the overall system controller as feedback. For example, the master controller 50 could receive a hydrogen tank pressure reading (or readings) from one or more hydrogen tanks. This information may be used by the master controller 50 in re-allocating individual power requirements amongst the power modules. The master controller 50 could also relay the hydrogen tank pressure reading to an overall system controller which could make adjustments (e.g. to its overall power requirement) based on a control feedback algorithm. Alternatively, the hydrogen tank pressure reading could be relayed by the master controller 50 to a gauge or meter on a vehicle's instrumentation panel for informing the driver of the vehicle of the amount of hydrogen pressure remaining in the tank. While hydrogen tank pressure is one example of performance data that could be relayed by the master controller to the overall system controller or user, it should be apparent to those of ordinary skill in the art that other performance data could be conveyed in like manner, e.g. the master controller 50 could also relay sensor information such as temperature, humidity, electrical current and voltage, etc. By relaying this sensor information to a vehicle's gauges, meters or other instrumentation, the driver or user is kept informed as to the fuel cell power system's overall performance, failures and/or available capacity, e.g. remaining pressure of hydrogen in the tank.

Furthermore, the master controller 50 can monitor faults and determine when to shut down and bypass a given fuel cell power module or when to reallocate load based on relative performance of the fuel cell power modules. As noted above, a variety of sensors and transducers are disposed through each of the fuel cell power modules. Each local controller continually or intermittently processes signals received from these sensors and transducers in order to verify that a fault has not occurred, i.e. that acceptable limits have not been transgressed. Some examples of faults that are communicated to the master controller and then relayed to the overall system controller are stack undervoltage, fuel cell power module overtemperature, hydrogen overpressure, hydrogen leak, coolant pump relay fault, blower fault, shutoff valve fault, cathode saturator motor fault, etc.

The master controller 50 may be pre-programmed to operate the fuel cell power system 10 based on a feedback control algorithm or it can be adapted to receive input from a user or operator (e.g. a driver of a vehicle). The master controller 50 sends commands or requests in the form of data or signals to local controllers 100, 200, 300 which, in turn, control the operation of associated fuel cell power modules to meet the overall system power requirement. The local controllers 100, 200, 300 also monitor the operating parameters collected by sensors and transducers at various locations within associated fuel cell power modules. These operating parameters include pressure, temperature, humidity, current, voltage, etc, at various locations. The function of the local controllers may include those disclosed in the applicant's co-pending U.S. patent application Ser. Nos. 10/122,125, 60/412,547, 60/412,548, 60/412,587, 60/412,588, 60/429,317, 60/429,318, 60/429,323, 10/461,870. Furthermore, the master controller 50 also reads feedback from the local controllers 100, 200, 300 to monitor the performance of each fuel cell power module 150, 250, 350.

It is to be understood that the communication lines 130, 230, 330 between the master controller 50 and the communication lines 120, 220, 320 between the local controller 100, 200, 300 are generally used herein to indicate communications between the master controller and the local controllers and between the local controllers and associated fuel cell power modules and hence should be construed generally. For example, each local controller may send commands or requests to respective fuel cells and their associated peripheral devices and, in return, receive signals/readings from sensors on these fuel cells and/or associated peripheral devices.

In the first embodiment of this invention, the fuel cell power modules (“FCPM”) 150, 250, 350 are each independent components. In other words, the FCPMs operate independently and are controlled independently by the respective local controllers. However, it is also possible to have a fuel cell power system 10 in which each local controller controls a grouping of fuel cell power modules.

Unlike conventional fuel cell power systems having multiple fuel cell stacks, the fuel cell power system 10 in accordance with the present invention does not simply electrically connect fuel cell stacks in series. Rather, the fuel cell power system 10 employs a modular system design. The overall fuel cell power system 10 can be easily scaled according to the total power output requirement of a particular application by simply adding or removing individual fuel cell power modules to or from the system 10. Preferably, fuel cell power modules are identical. This eliminates the need to reconfigure and/or recalibrate fuel cell peripheral devices for every different application. This simplifies manufacturing of the fuel cell power system, reduces cost and makes the system suitable for mass production. This modular design further enables the overall fuel cell power system to continue operating when some of the fuel cell power modules fail by bypassing the failed module(s).

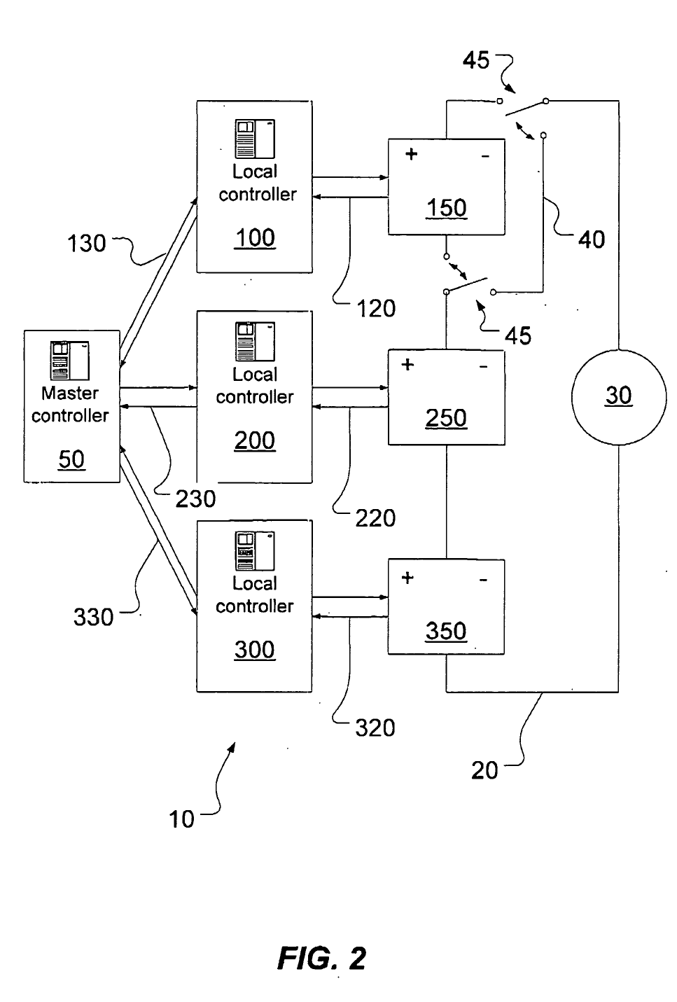

As shown in FIG. 2, a fuel cell power system 10 in accordance with a second embodiment of the present invention includes a bypass 40 (possibly also known as a bypass line or a bypass circuit). The bypass 40 enables the first fuel cell power module 150 to be bypassed in the event that it malfunctions, fails or is no longer required due to a diminished overall power requirement. The bypass 40 is controlled by the master controller 50 which operates a pair of switches 45 which can be opened to electrically isolate the fuel cell power module 150. Although FIG. 2 only shows a single bypass 40, it should be understood that the fuel cell power system 10 could include a bypass for each fuel cell power module so that any given module can be shut down and bypassed. Control of the bypass 40 can be managed by the master controller 50 based on overall system power requirements and performance or fault data from the local controller. In a variant, the local controller may also retain a certain autonomy to initiate the shut down and bypass of its own fuel cell power module. Whether the bypass is controlled by the master controller, the local controller or shared is a matter of design choice.

The capability of the fuel cell power system 10 to bypass a superfluous or faulty power module provides system reliability, robustness and flexibility. The power system can therefore survive fuel cell failures and respond efficiently to a wide range of power requirements.

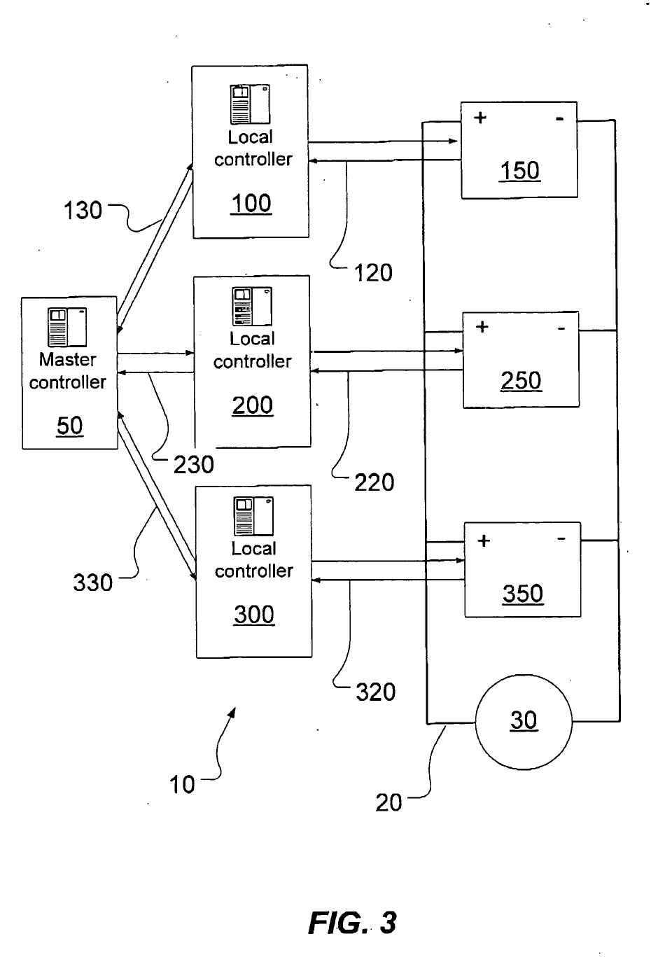

In order to provide greater power, the multiple fuel cell power modules 150, 250, 350 can be electrically connected in series in a circuit 20 to drive a load 30 as shown in FIGS. 1 and 2. Of course, as may be necessary, any number of fuel cell power modules in the multiple fuel cell power system of the present invention can be connected in parallel as shown in FIG. 3.

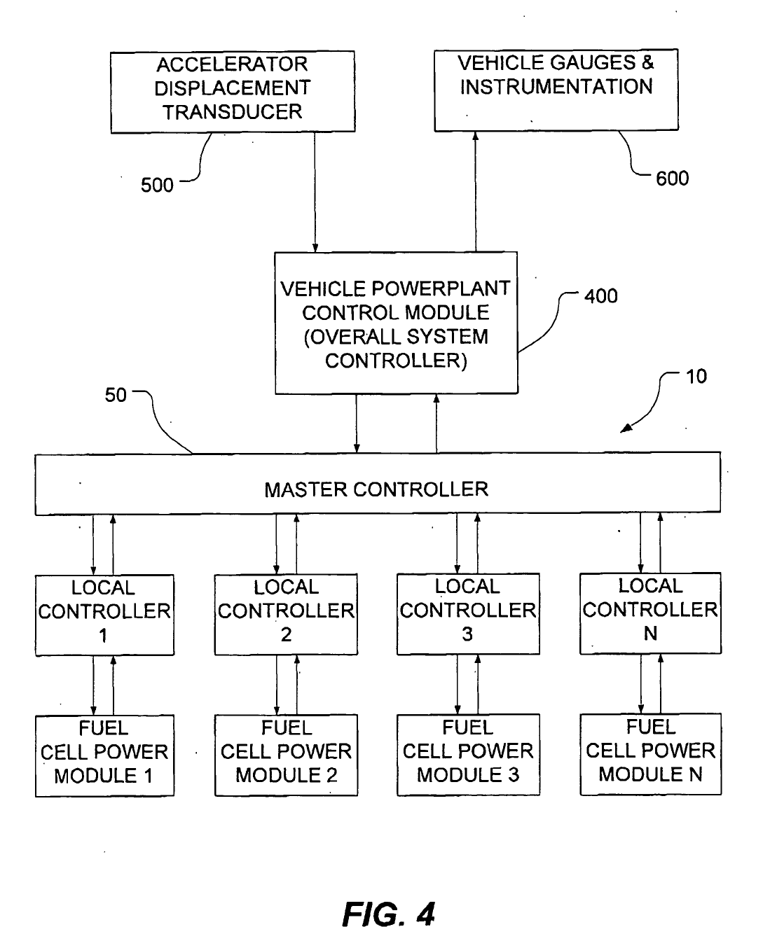

Referring to FIG. 4, the fuel cell power system 10 can be used for a variety of applications, including providing a motive force for a vehicle such as a car or a bus. Of course, persons of ordinary skill in the art will appreciate the present invention can be integrated into a hybrid propulsion system as well.

FIG. 4 shows schematically how the fuel cell power system 10 interacts with an overall system controller (OSC) such as a vehicle powerplant control module 400. When a user (i.e., a driver) depresses an accelerator (or equivalent device), an accelerator displacement transducer 500, or equivalent sensor, transmits an electrical signal to the vehicle powerplant control module 400 (i.e., the overall system controller). The vehicle powerplant control module 400 communicates a power requirement signal representing a total power requirement to the master controller 50 which, in turn, allocates the power requirement among the available fuel cell power modules and communicates a current draw to each local controller. In other words, the master controller 50 processes the power requirement signal from the OSC 400 to determine individual power generation requirements for each of the fuel cell power modules. Once these individual power requirements are determined and conveyed to each local controller, the local controllers then act as local feedback control systems to ensure that process parameters are maintained in appropriate ranges to enable the fuel cell reactions to produce the needed electricity according to their individuals production targets.

In one embodiment, the master controller 50 is linked with the local controllers 100, 200, 300 via a CANbus, i.e. a controller area network data bus. Alternatively, an interface using the RS232 protocol can be used for interlinking the master and local controllers.

While the above describes the preferred embodiments, it should be appreciated that the present invention is susceptible to modification and change without departing from the fair meaning and the proper scope of the accompanying claims. For example, the fuel cell power modules are not limited to those disclosed in the applicant's aforementioned co-pending US Patent Applications. The present invention might have applicability in various types of fuel cells, which include but are not limited to, solid oxide, alkaline, molton carbonate, and phosphoric acid.

Modifications and improvements to the above-described embodiments of the present invention may become apparent to those skilled in the art. The foregoing description is intended to be exemplary rather than limiting. The scope of the invention is therefore intended to be limited solely by the scope of the appended claims.

1. A fuel cell power system comprising:
a plurality of fuel cell power modules, each fuel cell power module including a fuel cell for generating electrical power;
a plurality of local controllers, each local controller controlling one respective fuel cell power module; and
a master controller for controlling the local controllers.

2. The fuel cell power system as claimed in claim 1 wherein the fuel cell power modules are electrically connected in series.

3. The fuel cell power system as claimed in claim 2 further comprising a bypass electrically connected in parallel across one respective fuel cell power module for selectively bypassing the fuel cell power module.

4. The fuel cell power system as claimed in claim 2 further comprising a plurality of bypasses electrically connected in parallel across respective fuel cell power modules for selectively bypassing the fuel cell power modules.

5. The fuel cell power system as claimed in claim 3 wherein the fuel cell power modules are substantially identical.

6. The fuel cell power system as claimed in claim 1 wherein the fuel cell power modules are electrically connected in parallel.

7. The fuel cell power system as claimed in claim 6 wherein the fuel cell power modules are substantially identical.

8. The fuel cell power system as claimed in claim 1 wherein the master controller comprises a plurality of data communications ports connected to data communication links linking the master controller with respective data communication ports on the local controllers.

9. The fuel cell power system as claimed in claim 8 wherein the master controller comprises an additional data communications port for receiving a power requirement signal from an overall system controller.

10. The fuel cell power system as claimed in claim 9 wherein the master controller and local controllers are linked using a CANbus controller area network.

11. A method of controlling a fuel cell power system having a plurality of fuel cell power modules, the method comprising the steps of:
locally controlling each fuel cell power module using a respective local controller; and
globally controlling the local controllers using a master controller.

12. The method as claimed in claim 11 wherein the step of globally controlling the local controllers comprises the steps of:
receiving a power requirement signal representing a total power requirement; and
processing the power requirement signal to determine individual power generation requirements for each of the fuel cell power modules.

13. The method as claimed in claim 12 wherein the step of processing the power requirement signal to determine individual power generation requirements for each of the fuel cell power modules comprises the steps of:
monitoring performance of each of the fuel cell power modules; and
optimally allocating individual power generation requirements based on performance, thereby providing optimal load-sharing.

14. The method as claimed in claim 11 further comprising the step of selectively bypassing at least one of the fuel cell power modules.

15. The method as claimed in claim 14 wherein the step of bypassing at least one of the fuel cell power modules comprises the step of receiving a fault signal at the master controller necessitating shut-down of a faulty fuel cell power module.

16. The method as claimed in claim 14 wherein the step of bypassing at least one of the fuel cell power modules comprises the step of shutting down at least one of the fuel cell power modules when the master controller determines that a total power generated by the fuel cell power system far exceeds the total power requirement such that the total power requirement can be more efficiently satisfied by running fewer fuel cell power modules.

17. The method as claimed in claim 11 further comprising the steps of:
receiving system performance data at the master controller from sensors located at each of the fuel cell power modules;
processing the system performance data at the master controller to provide feedback control of the local controllers;
relaying selected system performance data to an overall system controller.

18. The method as claimed in claim 17 wherein the step of relaying selected system performance data to an overall system controller comprises the step of presenting the system performance data to a user.

19. A fuel cell power system comprising:
a plurality of fuel cell power modules, each fuel cell power module including a fuel cell for generating electrical power and further including associated peripheral devices for supplying reactants to the fuel cell and for collecting current and reaction byproducts from the fuel cell;
a plurality of local controllers, each local controller controlling one respective fuel cell power module based on a feedback control loop from sensors disposed in the associated peripheral devices; and
a master controller for controlling the local controllers based on a master feedback control loop receiving feedback from each local controller from which the master controller generates control commands for each local controller.

20. The fuel cell power system as claimed in claim 19 further comprising a bypass electrically connected in parallel across one respective fuel cell power module for selectively bypassing the fuel cell power module.

21. The fuel cell power system as claimed in claim 19 further comprising a plurality of bypasses electrically connected in parallel across respective fuel cell power modules for selectively bypassing the fuel cell power modules.
